(19) United States
(12) Patent Application Publication
(10) Pub. No.: US 2003/0180017 A1
(43) Pub. Date: Sep. 25, 2003

(54) Flame retardant optical fiber cord and manufacturing method for the same

(75) Inventors: Tetsuo Hayano, Narita-shi (JP); Osamu Katoh, Osaka-shi (JP); Tsuyoshi Shimomichi, Sanbu-gun (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: FUJIKURA LTD., Tokyo (JP)

(21) Appl. No.: 10/390,659

(22) Filed: Mar. 19, 2003

(30) Foreign Application Priority Data
Nov. 15, 2002 (JP) 2002-332343
Mar. 19, 2002 (JP) 2002-076353

(51) Int. Cl. G02B 6/44

(52) U.S. Cl. 385/100

(57) ABSTRACT

A flame retardant optical fiber cord having improved flame retardancy without compromising the mechanical characteristics is described. The flame retardant optical fiber cord comprises: an optical fiber; a fiber buffering layer comprising high tension fibers arranged on the optical fiber; and a plastic sheath covering the fiber buffering layer, wherein at least the fiber buffering layer is made flame retardant with a halogen-free flame retarder in the form of a powder.

### CROSS REFERENCE TO RELATED APPLICATIONS

The subject application is related to subject matter disclosed in the Japanese Patent Application No.2002-76353 filed in Mar. 19, 2002 in Japan and the Japanese Patent Applications No.2002-332343 filed in Nov. 15, 2002 in Japan, to which the subject application claims priority under the Paris Convention and which are incorporated by reference herein.

### BACKGROUN OF THE INVENTION

1. Field of the Invention

The present invention relates to an optical fiber cord having high flame retardancy and improved mechanical characteristics and the manufacturing method for the same.

2. Description of the Related Art

Optical fiber cords have been used for wiring inside or outside of optical devices and so forth. An optical single fiber cord is composed of a bare glass fiber coated with a primary coating layer and a secondary coating layer made of a polyamide resin and the like, protected by a tension member made of aramid fibers and the like which are located around the optical single fiber in parallel, and coated with a vinyl chloride resin by an extrusion method. While such an optical fiber cord is preferred because of its flame resistance and good mechanical characteristics, there is a problem that a vinyl chloride resin generates a harmful gaseous halogen and the like when burning up. For this reason, it is proposed to make use of an olefin resin which is a burn-resistant halogen-free material in place of a vinyl chloride resin. However, since a great amount of an inorganic metal hydrate such as magnesium hydroxide is added to a burn-resistant olefin resin, the mechanical characteristics such as the tensile strength and tractility of the optical fiber cord are compromised. Particularly, in the case where the diameter of the optical fiber cord is small, a persistent curve often remains resulting in problems such as increasing the transmission loss. In this situation, several measures have been proposed to remove the problems by making use of another flame retarder(s) in place of or in addition to an inorganic metal hydrate as described above. However, little improvement has been achieved in the burn-resistant characteristics by these measures while, depending upon the selection of such a flame retarder, the burn-resistant olefin base resin as described above is stained by the flame retarder. Furthermore, the workability of the burn-resistant olefin resin as described above is not so good from the view point of the fluidity thereof. With respect to the technique of this kind, as illustrated in Japanese Patent Published Application No. 2001-221935, for example, the coating layer of an optical fiber is made flame retardant. However, in the case where a large amount of a flame retarder is added to the coating layer, there is the problem of compromising the mechanical characteristics such as the flexibility of the optical fiber.

### BRIEF SUMMARY OF THE INVENTION

The present invention has been made in order to solve the shortcomings as described above. It is an object of the present invention to provide a flame retardant optical fiber cord and a manufacturing method for the same wherein the optical fiber cord is excellent in suppleness (flexibility) and in flame retardancy, and can be manufactured by a relatively simple manufacturing method and in compliance with the requirement for decreasing the diameter thereof.

In accordance with an aspect of the present invention, a flame retardant optical fiber cord comprises: an optical fiber; a fiber buffering layer comprising high tension fibers arranged on said optical fiber; and a plastic sheath covering said fiber buffering layer, wherein at least said fiber buffering layer is made flame retardant with a halogen-free flame retarder in the form of a powder.

In accordance with anther aspect of the present invention, a manufacturing method of manufacturing a flame retardant optical fiber cord comprises: a step of arranging high tension fibers in parallel on an optical fiber and forming a fiber buffering layer; a step of passing said optical fiber provided with said fiber buffering layer through a flame retardant bath containing a halogen-free flame retarder in the form of a powder and applying (adhering) said halogen-free flame retarder to at least said fiber buffering layer to form a flame retardant layer; and a step of covering said optical fiber, on which is formed said flame retardant layer, with a plastic sheath by an extrusion apparatus.

In accordance with a further aspect of the present invention, a manufacturing method of manufacturing a flame retardant optical fiber cord comprises: a step of arranging high tension fibers in parallel on an optical fiber and forming a fiber buffering layer; a step of passing said optical fiber provided with said fiber buffering layer through a flame retardant bath containing a slurry of a halogen-free flame retarder in the form of a powder and applying (adhering) said halogen-free flame retarder to at least said fiber buffering layer to form a flame retardant layer; and a step of drying said optical fiber, to which said flame retardant layer is applied, by a drying furnace.

In accordance with a further aspect of the present invention, a manufacturing method of manufacturing a flame retardant optical fiber cord comprises: a step of arranging in parallel high tension fibers, which is made flame retardant in advance with a halogen-free flame retarder in the form of a powder, on an optical fiber and forming a fiber buffering layer; and a step of covering said optical fiber, on which is formed said fiber buffering layer, with a plastic sheath by an extrusion apparatus.

In accordance with a further aspect of the present invention, a flame retardant optical fiber cord comprises: an optical fiber; a fiber buffering layer comprising high tension fibers arranged on said optical fiber; and a plastic sheath covering said fiber buffering layer, wherein at least said high tension fibers is made flame retardant with a halogen-free flame retarder in the form of a powder.

In accordance with a further aspect of the present invention, a manufacturing method of manufacturing a flame retardant optical fiber cord comprises: a step of arranging high tension fibers in parallel on an optical fiber and forming a fiber buffering layer; a step of passing said optical fiber provided with said fiber buffering layer through a flame retardant bath containing a halogen-free flame retarder in the form of a solution and applying (adhering) said halogen-free flame retarder to at least said fiber buffering layer to form a flame retardant layer; a step of drying said optical fiber, to which said flame retardant layer is applied, by a drying furnace; and a step of covering said optical fiber as dried with a plastic sheath by an extrusion apparatus.

In accordance with a further aspect of the present invention, a manufacturing method of manufacturing a flame retardant optical fiber cord comprises: a step of arranging high tension fibers in parallel on an optical fiber and forming a fiber buffering layer; a step of spraying said optical fiber provided with said fiber buffering layer with a solution including a halogen-free flame retarder and applying (adhering) said halogen-free flame retarder to at least said fiber buffering layer to form a flame retardant layer; and a step of drying said optical fiber, to which said flame retardant layer is applied, by a drying furnace; and a step of covering said optical fiber as dried with a plastic sheath by an extrusion apparatus.

In accordance with a further aspect of the present invention, a manufacturing method of manufacturing a flame retardant optical fiber cord comprises: a step of arranging in parallel high tension fibers, which is made flame retardant in Advance with a halogen-free flame retarder in the form of a solution, on an optical fiber and forming a fiber buffering layer; and a step of covering said optical fiber as dried with a plastic sheath by an extrusion apparatus.

In accordance with a further aspect of the present invention, a flame retardant optical fiber cord comprises: a transparent wire having optical characteristics as required of said flame retardant optical fiber cord; a primary coating layer directly covering the external surface of said fiber glass structure; a secondary coating layer covering the external surface of said transparent wire through said primary coating layer; a fiber buffering layer comprising high tension fibers arranged on said secondary coating layer; and a plastic sheath covering said fiber buffering layer, wherein a halogen-free flame retarder is interposed between said high tension fibers.

In accordance with a further aspect of the present invention, a flame retardant optical fiber cord comprises: a transparent wire having optical characteristics as required of said flame retardant optical fiber cord; a primary coating layer directly covering the external surface of said fiber glass structure; a secondary coating layer covering the external surface of said transparent wire through said primary coating layer; a fiber buffering layer comprising high tension fibers arranged on said secondary coating layer; and a flame retardant layer comprising a halogen-free flame retarder and covering said fiber buffering layer.

### BRIEF DESCRIPTION OF THE DRAWINGS

The aforementioned and other features and objects of the present invention and the manner of attaining them will become more apparent and the invention itself will be best understood by reference to the following description of a preferred embodiment taken in conjunction with the accompanying drawings, wherein:

FIG. 1 is a schematic cross section view showing a flame retardant optical fiber cord in accordance with the present invention.

FIG. 2A is a schematic cross section view showing a flame retardant single optical fiber cord in accordance with the present invention.

On the other hand, FIG. 2B is a schematic cross section view showing a flame retardant optical fiber ribbon in accordance with the present invention.

FIG. 3 is a table showing the advantages of the present invention.

FIG. 4 is a table showing the advantages of the present invention.

FIG. 5 is a schematic diagram showing a manufacturing method of a flame retardant optical fiber cord in accordance with the present invention.

FIG. 6 is a schematic diagram showing another manufacturing method of a flame retardant optical fiber cord in accordance with the present invention.

FIG. 7 is a schematic diagram showing a further manufacturing method of a flame retardant optical fiber cord in accordance with the present invention.

### DETAILED DESCRIPTION OF THE INVENTION

Various embodiments of the present invention will be described with reference to the accompanying drawings. It is to be noted that the same or similar reference numerals are applied to the same or similar parts and elements throughout the drawings, and the description of the same or similar parts and elements will be omitted or simplified.

In the followings, various embodiments of the present invention will be described with reference to the accompanying drawings.

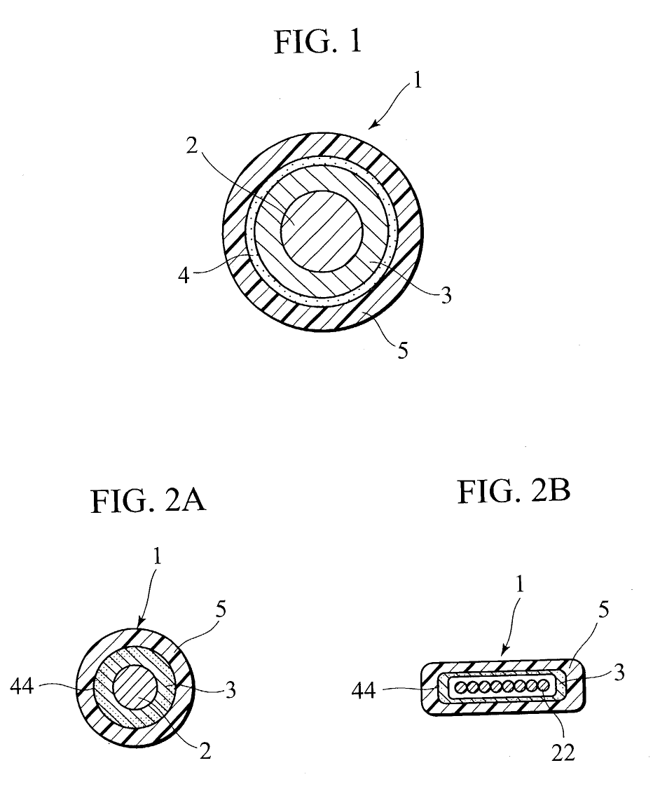

FIG. 1 is a schematic cross section view showing a flame retardant optical fiber cord in accordance with the present invention. In this case, the flame retardant optical fiber cord 1 is composed of an optical fiber 2, a fiber buffering layer 3, a flame retardant layer 4 and a plastic sheath 5. The optical fiber 2 is composed of a transparent structure (transparent wire) having optical characteristics as required of the fiber such as a wire made of a vitreous material(s), a primary coating layer and a secondary coating layer made of a rigid UV curable resin, a polyamide resin or a polyolefin base resin and the like. The glass core structure as covered only by the primary coating layer are often referred to as an optical fiber core wire. In accordance with the present invention, it is possible to dispense with the treatment required for making flame retardant this coating layer. This means that the mechanical characteristics of the optical fiber cord as obtained are not compromised so that the optical fiber cord is excellent in suppleness (flexibility). The fiber buffering layer 3 is a fiber buffering layer as a strength member which is made of high tension fibers such as aramid fibers (proprietary name: Kevler, Twaron and the like), PBO (proprietary name: Xyron and the like) and so forth which are located around the optical fiber in parallel. For example, four KEVLAR fibers are arranged around a single fiber having a diameter of 0.9 mm. The flame retardant layer 4 is made of a halogen-free flame retarder in the form of a powder formed at least on the fiber buffering layer 3. In this case, the flame retardant layer 4 is formed by applying the halogen-free flame retarder in the form of a powder to the fiber buffering layer 3, for example, by coating (adhering) so that the halogen-free flame retarder can be not only applied the surface of the fiber buffering layer 3 but also inserted to spaces among the KEVLAR fibers as described above and also placed onto the optical fiber 2. Namely, the halogen-free flame retardant substance is applied in order to come into contact with the secondary coating layer of the optical fiber 2. By this configuration, the flame retardancy of the flame retardant layer 4 become effective.

Then, the halogen-free flame retarder in the form of a powder is made of, for example, a fine powder of a metal inorganic hydroxide such as magnesium hydroxide or aluminum hydroxide, a fine powder of a nitrogen based flame retarder such as ammonium polyphosphate, red phosphorus, a melamine cyanurate, a melamine powder and the like. Particularly, it is preferred to make use of an inorganic metal hydrate such as magnesium hydroxide, among the above described halogen-free flame retarders, which is decomposed to generate water when burned and shows its flame retardancy by an endothermic reaction. Then, the halogen-free flame retarder in the form of a powder is applied at least to the fiber buffering layer 3 by coating (adhering) or any one of a variety of other applicable methods as described below in order to function as the flame retardant layer 4. In this case, it is preferred to select the average particle diameter of the flame retarder in the form of a powder within the range as described below for the purpose of uniformly and certainly applying the flame retarder to the entirety of the fiber buffering layer 3, into spaces among the KEVLAR fibers as described above and on the optical fiber.

The plastic sheath 5 is a plastic sheath for covering the flame retardant layer 4. The plastic sheath 5 is typically made of a thermoplastic polymer resin. For example, the plastic sheath 5 is formed of a polyolefin base copolymer alone or as a component of a mixture, for example, an ethylene vinyl acetate copolymer, an ethylene acrylic rubber copolymer, ethylene ethyl acrylate copolymer and the like, or a polyamide resin, a polyester resin, a polybutylehe terephthalate (PBT) and the like in accordance with an extrusion method. Then, in the case of the flame retardant optical fiber cord 1 in accordance with the present invention, it is no longer needed to make highly flame retardant the plastic sheath 5 by adding a large amount of the inorganic metal hydrate and therefore it is possible to maintain the characteristics required of the plastic sheath 5, for example, a tensile stress strength of no lower than 10 MPa and an elongation at break of no lower than 100%. Also, in accordance with the present invention, it is preferred that the flame retardant treatment is carried out within 39 to 55 as an Oxygen Index (OI) in order not to compromise the mechanical characteristics as described above. Since the flame retardant layer 4 is formed and basically located between the fiber buffering layer 3 and the plastic sheath 5, in the case of an inorganic metal hydrate, water is smoothly generated by thermal decomposition when burned, resulting in improved burn-resistant effects, as compared with the case where a flame retarder is kneaded within the plastic material of the plastic sheath. As a result, the flame retardant optical fiber cord 1 as configured above has a sufficient flame retardancy to pass the UL 1581 Vertical Wire Flame Test VW-1.

Next, with reference to FIG. 2, other examples of the flame retardant optical fiber cords 1 in accordance with the present invention will be briefly explained. FIG. 2A is a schematic cross section view showing a flame retardant single optical fiber cord in accordance with the present invention. On the other hand, FIG. 2B is a schematic cross section view showing a flame retardant optical fiber ribbon in accordance with the present invention. The flame retardant optical fiber cord 1 as illustrated in FIG. 2A is composed of is composed of an optical fiber 2, a fiber buffering layer 3, a flame retarder 44 and a plastic sheath 5. The optical fiber 2 is composed of an glass core structure having optical characteristics as required of the fiber, a primary coating layer and a secondary coating layer made of a rigid UV curable resin, a polyamide resin or a polyolefin base resin and the like. The glass core structure and the primary coating layer is often referred to as an optical fiber core wire. In accordance with the present invention, it is possible to dispense with the treatment required for making flame retardant these coating layers. This means that the mechanical characteristics of the optical fiber cord as obtained are not degraded so that the optical fiber cord is excellent in suppleness (flexibility). The fiber buffering layer 3 is a fiber buffering layer composed of high tension fibers such as aramid fibers (proprietary name: Kevler, Twaron and the like), PBO (proprietary name: Xyron and the like) and so forth which are located around the optical fiber in parallel. For example, four KEVLAR fibers 1140d are arranged as high tension fibers around a single fiber having a diameter of 0.9 mm. The high tension fibers are given the treatment required for making it flame retardant in advance or when the optical fiber cord 1 is manufactured. Thereby, the halogen-free flame retarder 44 in the form of a powder or a solution is applied (coated) to the fiber buffering layer 3 not only in a layered condition but also in an impregnated and dispersed condition to make flame retardant the fiber buffering layer 3. Then, the halogen-free flame retarder used here for the purpose of making flame retardant the fiber buffering layer is made of, for example, a fine powder of a metal inorganic hydroxide such as magnesium hydroxide or aluminum hydroxide, an phosphoric ester such as resorcinol diphenylphosphate, a nitrogen based flame retarder such as ammonium polyphosphate, red phosphorus, a melamine cyanurate, a melamine powder and the like as described above in the form of a powder as it is, in the form of a slurry or in the form of a solution thereof. In the case where the halogen-free flame retarder is made of an inorganic metal hydrate as described above, it is preferred that the high tension fibers is impregnated (or coated) with the flame retarder with a density of a 1 g/m or higher. Also, the plastic sheath 5 covering the fiber buffering layer 3 is made of the same material as described above. While the single optical fiber cord has been described in the above description, the present invention is also effectively applied to an optical fiber cord in which a plurality of optical fibers are twisted, an optical fiber cord in which a plurality of optical fibers are bundled in parallel, or an optical fiber ribbon in which a plurality of optical fibers are arranged in a line as illustrated in FIG. 2B. Then, the flame retardant optical fiber cord of the structure as described above has a sufficient flame retardancy to pass the UL 1581 Vertical Wire Flame Test VW-1 while the transmission loss is increased only by no higher than 0.01 dB/km by applying the flame retarder.

Accordingly, in accordance with the embodiment of the present invention, the optical fiber cord is formed by providing a fiber buffering layer made of high tension fibers and then a plastic sheath on an optical fiber or an optical fiber ribbon wherein at least the fiber buffering layer is given a flame retardant treatment with a halogen-free flame retarder in the form of a powder, and therefore the mechanical characteristics of the optical fiber cord as obtained are not compromised so that the optical fiber cord is excellent in suppleness (flexibility) and in flame retardancy due to the flame retardancy of the halogen-free flame retarder. Needless to say, the flame retardant optical fiber cord does not generate any halogen compound even when burned. Namely, the flame retardant optical fiber cord in accordance with the present invention is made flame retardant by providing the fiber buffering layer of high tension fibers having a highly flame retardancy characteristics and located around the optical fiber rather than giving a flame retardant treatment to the coating layer of the optical fiber, and therefore it is possible to make use of the flame retardancy of the halogen-free flame retarder and obtain excellent mechanical characteristics. By this configuration, it is possible to maintain the mechanical characteristics of the coating layer of the optical fiber according to the original mechanical characteristics of the plastic and therefore to realize the flame retardant optical fiber cord with excellent mechanical characteristics. The flame retardation of the high tension fibers is performed by the use of the halogen-free flame retarder in the form of a powder. Also, while the flame retardation can be performed by a variety of alternate techniques as described below, it is basically preferred that the halogen-free flame retarder is sufficiently applied or attached (or held) to the high tension fibers and to the inside of the fiber buffering layer when forming the fiber buffering layer. The detailed information is given as explained in the following description.

Also, in accordance with the embodiment of the present invention, it is possible to improve the flame retardation characteristics of the flame retardant optical fiber cord, equivalent to the prior art flame retardant optical fiber cord as described above, by the flame retardation process in which the flame retardant layer of the halogen-free flame retarder in the form of a powder is formed at least on the fiber buffering layer. That is, since the halogen-free flame retarder is used as a flame retarder in the form of a powder, the flame retardant optical fiber cord is also halogen-free and therefore has high flame retardancy. Also, in accordance with the present invention, it is possible to dispense with the treatment of making flame retardant the coating layer of the optical fiber and therefore to prevent the mechanical characteristics, for example, the suppleness (flexibility) of the optical fiber from being degraded. Furthermore, since the halogen-free flame retarder is made flame retardant by coating (adhering) a flame retarder in the form of a powder onto the fiber buffering layer, the flame retarder tend to be effective and advantageous, resulting in a highly flame retardant optical fiber cord.

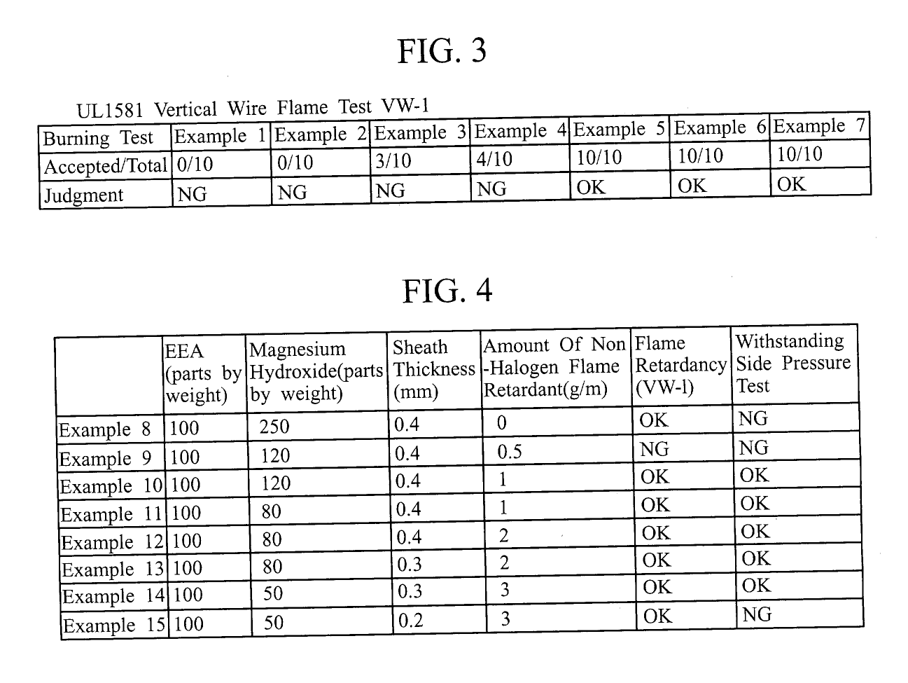

In what follows, several experimental examples will be described in order to explain the advantages of the present invention. In these experiments, seven types of sample single optical fiber codes were prepared as described below and subjected to the UL 1581 Vertical Wire Flame Test VW-1 in order to evaluate the flame retardancy thereof. All of the samples were prepared in the form of single optical fiber codes each of which had a diameter of 2 mm. 10 samples were prepared for each type and subjected to the UL 1581 Vertical Wire Flame Test VW-1. In the evaluation tests, each of the ten samples was ignited for five times. Each type of the single optical fiber codes was evaluated as acceptable to pass the test when the fire was always extinct within one minutes after the ignition for any of the ten samples. FIG. 3 is a table showing the result of the UL 1581 Vertical Wire Flame Test VW-1.

### EXPERIMENTAL EXAMPLE 1

KEVLAR fibers (1140d×4) were arranged around a single fiber having a diameter of 0.9 mm, and then covered thereover with a plastic sheath made of a halogen-free flame retardant resin compound having an Oxygen Index (OI) of 39 (an ethylene vinyl acetate copolymer as made flame retardant by mixing magnesium hydroxide therewith) by an extrusion method in the form of a flame retardant optical fiber cord having a diameter of 2 mm as a sample.

### EXPERIMENTAL EXAMPLE 2

After preparing a single fiber having a diameter of 0.9 mm with a secondary coating layer as made flame retardant by mixing magnesium hydroxide, KEVLAR fibers (1140d×4) were arranged around the single fiber, and then covered thereover with a plastic sheath made of a halogen-free flame retardant resin compound having an Oxygen Index of 39 (an ethylene vinyl acetate copolymer as made flame retardant by mixing magnesium hydroxide therewith) by an extrusion method in the form of a flame retardant optical fiber cord having a diameter of 2 mm as a sample.

### EXPERIMENTAL EXAMPLE 3

KEVLAR fibers (1140d×4) were arranged around a single fiber having a diameter of 0.9 mm, and then covered thereover with a plastic sheath made of a halogen-free flame retardant resin compound having an Oxygen Index (OI) of 53 (a mixture of ethylene vinyl acetate copolymer and ethylene acrylic rubber copolymer, as made flame retardant by mixing magnesium hydroxide therewith) by an extrusion method in the form of a flame retardant optical fiber cord having a diameter of 2 mm as a sample.

### EXPERIMENTAL EXAMPLE 4

After preparing a single fiber having a diameter of 0.9 mm with a secondary coating layer as made flame retardant by mixing magnesium hydroxide, KEVLAR fibers (1140d×4) were arranged around the single fiber, and then covered thereover with a plastic sheath made of a halogen-free flame retardant resin compound having an Oxygen Index of 53 (a mixture of ethylene vinyl acetate copolymer and ethylene acrylic rubber copolymer, as made flame retardant by mixing magnesium hydroxide therewith) by an extrusion method in the form of a flame retardant optical fiber cord having a diameter of 2 mm as a sample.

### EXPERIMENTAL EXAMPLE 5

KEVLAR fibers (1140d×4) were arranged as a fiber buffering layer around a single fiber having a diameter of 0.9 mm, then covered thereover with a flame retardant layer made of a magnesium hydroxide powder having an average particle diameter of 0.8 micrometer and further covered by a plastic sheath made of a halogen-free flame retardant resin compound having an Oxygen Index (OI) of 39 (an ethylene vinyl acetate copolymer as made flame retardant by mixing magnesium hydroxide therewith) by an extrusion method in the form of a flame retardant optical fiber cord having a diameter of 2 mm as a sample.

### EXPERIMENTAL EXAMPLE 6

KEVLAR fibers (1140d×4) were arranged as a fiber buffering layer around a single fiber having a diameter of 0.9 mm, then covered thereover with a flame retardant layer made of a magnesium hydroxide powder having an average particle diameter of 0.8 micrometer and further covered by a plastic sheath made of a halogen-free flame retardant resin compound having an Oxygen Index (OI) of 39 (a mixture of ethylene vinyl acetate copolymer and ethylene acrylic rubber copolymer, as made flame retardant by mixing magnesium hydroxide therewith) by an extrusion method in the form of a flame retardant optical fiber cord having a diameter of 2 mm as a sample.

### EXPERIMENTAL EXAMPLE 7

KEVLAR fibers (1140d×4) were arranged as a fiber buffering layer around a single fiber having a diameter of 0.9 mm, then covered thereover with a flame retardant layer made of a magnesium hydroxide powder having an average particle diameter of 0.8 micrometer and further covered by a plastic sheath made of a halogen-free flame retardant resin compound having an Oxygen Index (OI) of 53 (a mixture of ethylene vinyl acetate copolymer and ethylene acrylic rubber copolymer, as made flame retardant by mixing magnesium hydroxide therewith) by an extrusion method in the form of a flame retardant optical fiber cord having a diameter of 2 mm as a sample.

As apparent from the table as illustrated in FIG. 3, only the flame retardant optical fiber cords corresponding to the experimental examples 5 to 7 passed the UL 1581 Vertical Wire Flame Test VW-1 requiring the passing status of all the ten samples while the remaining experimental examples 1 to 4 did not pass the Test. As a result, it is confirmed that the flame retardancy of the flame retardant optical fiber cord are improved by the use of the structure in accordance with the present invention as compared with the structure in accordance with a conventional technique even if the same flame retarder is used. This is because, in the case where magnesium hydroxide is used as the flame retarder for example, the flame retardancy of the flame retarder as used in accordance with the present invention becomes more effective than the flame retardancy of conventional structures in which the flame retarder is mixed with a resin and the like. Namely, moisture as generated from the flame retarder during burning effectively causes an endoergic reaction to perform a quenching action. Conversely, in the case where only the sheath material was made flame retardant as in the experimental examples 1 and 3, only 30% of 10 samples at most passed the test even if the Oxygen Index was increased (as in the experimental example 3). Also, in the case of the embodiments 2 and 4 in which the coating layers of the optical fibers were made flame retardant as well as the sheath material, no sample having an Oxygen Index of 39 did not pass the test (the experimental example 2) while only 40% of the ten samples having an Oxygen Index of 53 passed the test (the experimental example 4). In addition to this, in the case of the structure of this type, it is inevitable to compromise the mechanical characteristics due to addition of a large amount of the flame retarder, resulting in problematic optical fiber cords. Contrary to this, the flame retardant optical fiber cord in accordance with the embodiment of the present invention has excellent mechanical characteristics such as a sufficient tensile stress strength (MPa) and a sufficient elongation at break (%) as a highly flame retardant optical fiber cord.

Also, in accordance with the flame retardant optical fiber cord of the embodiment of the present invention, it is possible to furthermore make flame retardant the entire optical fiber cord 1 by making flame retardant the plastic sheath 5 itself with the halogen-free flame retarder in addition to the halogen-free flame retarder as applied to the fiber buffering layer 3 in the form of a powder, and therefore to pass the UL 1581 Vertical Wire Flame Test VW-1. Furthermore, the flame retardant optical fiber cord has excellent mechanical characteristics such as flexibility. Also, since this flame retardant optical fiber cord 1 contains no halogen element, a harmful gaseous halogen such as dioxin shall not be generated and therefore environmental problems and the like shall not be issued.

Still further, taking into consideration the halogen-free flame retardancy of the fiber buffering layer 3, it is possible to arbitrarily select the thickness of the plastic sheath 5, while maintaining sufficient flame retardancy to pass the UL 1581 Vertical Wire Flame Test VW-1, and to suppress the increment of the transmission loss no higher than 0.1 dB. Then, in the case of the flame retardant optical fiber cord as described above, there does not occur the problem of compromising the mechanical characteristics such as the tensile strength and the suppleness (flexibility) of the optical fiber and the problem of generating a harmful gaseous halogen such as dioxin even if the cord is incinerated.

Next, other experiments will be explained. FIG. 4 is a table showing the results of the other experiments. Namely, the table as illustrated in FIG. 4 includes the specifications of each experiment making use of single optical fiber codes having an external diameter of 2 mm. Each of the single optical fiber codes was prepared by arranging aramid fibers, to which a magnesium hydroxide powder had been applied in advance, around a single fiber having a diameter of 0.9 mm, and then covered thereover with a plastic sheath made of EEA (ethylene ethyl acrylate copolymer) as made flame retardant by mixing magnesium hydroxide therewith). In this case, eight types of single optical fiber codes were prepared with 100 parts of EEA by weight while varying the amount (g/m) of the flame retarder made of magnesium hydroxide in the high tension fibers (aramid fibers) and the thickness (mm) of the plastic sheath. Ten samples were prepared for each type. With these sample codes, the UL 1581 Vertical Wire Flame Test VW-1 was performed for each ten samples. Each type of the single optical fiber codes was evaluated as acceptable to pass the test when the fire was always extinct within one minutes after the ignition for any of the ten samples. Also, the withstanding side pressure of each sample was measured in accordance with the IEC794-1 Crush test. Namely, a side pressure of 980 N was applied over a side pressure width of 100 mm to the code through which waves of 1.55 micrometer wavelength were propagated in order to measure the increase of the transmission loss by means of an OTDR (Optical Time Domain Reflectometer). Each type of the single optical fiber codes was evaluated as acceptable to pass the test when the increase of the transmission loss is no higher than 0.1 dB.

As illustrated in FIG. 4, the amount of the flame retarder comprising the inorganic metal hydrate as described above within the plastic sheath could be decreased to from 120 parts to 50 parts by weight with 100 parts by weight of the base polymer by applying the inorganic metal hydrate in the form of a powder to the high tension fibers with a density of 1 g/m. Also, it was confirmed that this structure of the flame retardant optical fiber cord had sufficient flame retardancy to pass the UL 1581 Vertical Wire Flame Test VW-1, and to suppress the increment of the transmission loss no higher than 0.1 dB corresponding to the withstanding side pressure characteristics. Furthermore, since the amount of the flame retarder in the sheath material was decreased, the mechanical characteristics such as the strength and the flexibility of the flame retardant optical fiber cord could be improved. More specifically speaking, if the plastic sheath was made of a material mixed with 250 parts by weight of the inorganic metal hydrate powder as in the experimental example 8, the withstanding side pressure exceeds 0.1 dB and therefore the withstanding side pressure characteristics were not accepted in practice while the flame retardancy are sufficient to pass the UL 1581 Vertical Wire Flame Test VW-1. Also, even if the plastic sheath was made of a material mixed with 120 parts by weight of the inorganic metal hydrate powder as in the experimental example 9, the flame retardancy were not sufficient to pass the UL 1581 Vertical Wire Flame Test VW-1 in the case where only 0.5 g/m of the flame retarder were applied to the high tension fibers. Furthermore, if the plastic sheath was made of a material mixed with 50 parts by weight of the inorganic metal hydrate powder, even when 3 g/m of the flame retarder were applied to the high tension fibers as in the experimental example 15, the withstanding side pressure with the thickness of the plastic sheath being 0.2 mm was not accepted.

From the experimental results as described above, it is understood that the amount of the halogen-free flame retarder in the form of a powder to be applied to the high tension fibers is preferably one or more gram per meter of the high tension fibers during the flame retardation treatment. This is because if the amount of the halogen-free flame retarder was 0.5 g/m, the flame retardancy could not pass the UL 1581 Vertical Wire Flame Test VW-1. Thus, with the flame retardant optical fiber cord configured as described above, it is possible to make effectively use of the flame retardancy of the halogen-free flame retarder and suppress the increase of the transmission loss without compromising the mechanical characteristics and without generation of a harmful gaseous halogen and the like when burning up.

Meanwhile, it is preferred that the halogen-free flame retarder in the form of a powder as described above has an average particle diameter of no larger than 1 micrometer. Namely, in the case of the flame retardant optical fiber cord in accordance with the present invention, the halogen-free flame retarder in the form of a powder as described above is applied to the fiber buffering layer 3 which is formed by arranging in parallel the high tension fibers made of aramid fibers and the like. It is therefore preferred that the powdered halogen-free flame retarder is not only applied to the entirety of the fiber buffering layer but also inserted to spaces among the aramid fibers and placed onto the optical fiber itself. For this reason, while the average particle diameter of the flame retarder is preferably small at a certain level, a number of experimental results indicate no larger than 1 micrometer as a preferred average particle diameter of the halogen-free flame retarder in the form of a powder as described above. If the average particle diameter is small in this level, it is possible to uniformly cover the entirety of the fiber buffering layer 3 with the particles, to insert the particles to spaces among the high tension fibers and apply the powder onto the optical fiber 2 itself.

Next, a method of manufacturing the flame retardant optical fiber cord as described above will be explained. Namely, after arranging in parallel high tension fibers around an optical fiber or an optical fiber ribbon which is being transported, the optical fiber or the optical fiber ribbon is passed through a flame retardant bath containing the halogen-free flame retarder in the form of a powder in order to apply (adhere) the halogen-free flame retarder at least to the fiber buffering layer. Thereafter, the optical fiber or the optical fiber ribbon is covered with a plastic sheath by means of an extrusion apparatus. Also, in this case, the application of the halogen-free flame retarder can be accelerated by shaking the flame retardant bath containing the halogen-free flame retarder in the form of a powder during application.

By this manufacturing method, the flame retardant layer 4 can be uniformly applied to the entirety of the fiber buffering layer 3. Also, by shaking the flame retardant bath, the halogen-free flame retarder in the form of a powder can be not only applied to the entirety of the fiber buffering layer 3 but also inserted among the high tension fibers of the fiber buffering layer 3 and applied to the optical fiber 2 itself. The manufacturing method does not require a large-scale system and can be carried out with a low cost as compared to the case where a flame retarder is mixed in a plastic sheath.

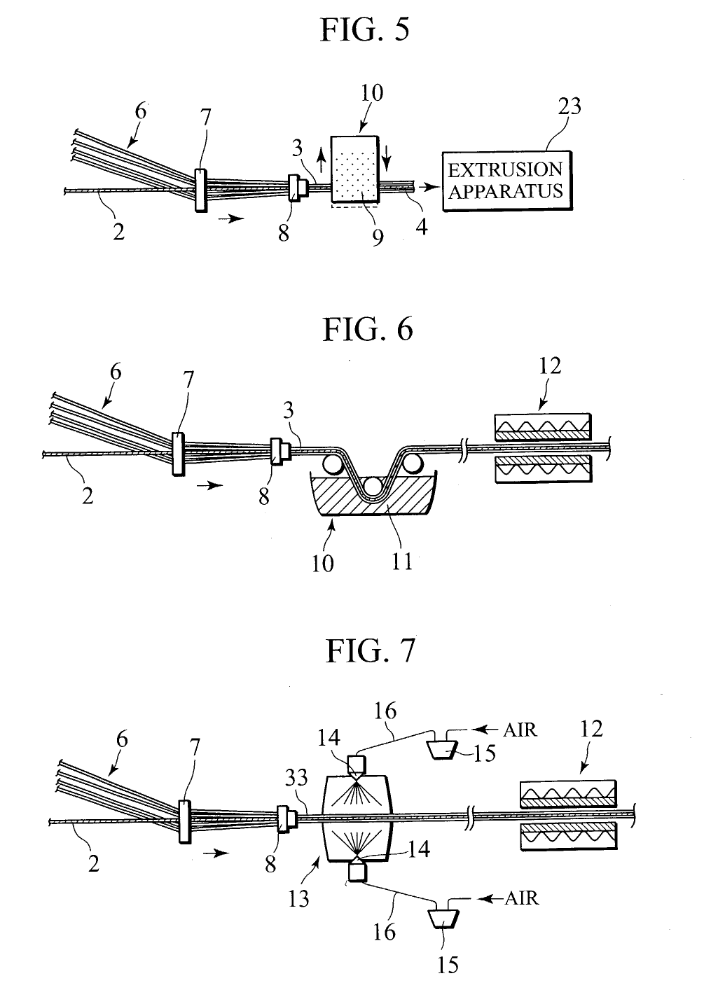

In what follows, this manufacturing method will be explained with reference to FIG. 5 in detail. It is assumed that the optical fiber 2 is transported from the left. On the other hand, high tension fibers 6 such as aramid fibers are also transported from the left and arranged around the optical fiber 2 in parallel through guide means 7. The optical fiber 2 and the high tension fibers 6 are then bundled by means of a bundling die 8 to form a fiber buffering layer 3. After forming the fiber buffering layer 3, the optical fiber 2 is introduced to the flame retardant bath 10 containing halogen-free flame retarder 9 in the form of a powder. The optical fiber 2 is then passed through the flame retardant bath 10 in which the flame retarder 9 in the form of a powder such as a magnesium hydroxide fine powder having an average particle diameter of about 0.8 micrometer is applied (or adhered) to the fiber buffering layer 3 in order to form the flame retardant layer 4. In this case, the flame retardant bath 10 is shaken as indicated with arrows (↑↓) as illustrated in FIG. 5 in order to facilitate uniform application of the flame retarder to the flame retardant layer 4, to spaces among the high tension fibers and onto the optical fiber. The optical fiber 2 provided with the flame retardant layer 4 is then successively transported to an extrusion apparatus 23 where the optical fiber 2 is covered with the plastic sheath 5 to form the flame retardant optical fiber cord 1. Meanwhile, the plastic sheath 5 is made of a thermoplastic plastic which is made flame retardant to an Oxygen Index of 39 to 55.

More specifically speaking about the formation of the flame retardant layer 4, it is possible to form the flame retardant layer 4 by rotating or moving the halogen-free flame retarder 9 itself in the form of a powder up and down or right and left rather than moving the flame retardant bath 10, or by blowing the powdered halogen-free flame retarder 9 from a nozzle or the like on the fiber buffering layer 3. Furthermore, it is possible to form the flame retardant layer 4 by coating the fiber buffering layer 3 with a slurry of a flame retarder in an organic solvent followed by removing the organic solvent by vaporization. Furthermore, the flame retardant layer 4 may be formed not only on the fiber buffering layer 3 but separately also on the optical fiber 2 by the use of a separate flame retardant bath. Namely, another flame retardant bath having the same structure as the flame retardant bath 10 may be provided for applying the flame retarder to the optical fiber 2 in advance of the guide means 7 where the high tension fibers 6 are arranged around the optical fiber 2. In the case where the flame retardant layer 4 is provided in the two locations, i.e., on both the fiber buffering layer 3 and the optical fiber 2, the flame retardancy can be furthermore improved. Furthermore, it is possible to make flame retardant the high tension fibers 6 itself.

Next, another manufacturing method of the flame retardant optical fiber cord will be explained. In accordance with the manufacturing method, the high tension fibers is made flame retardant by passing the fiber buffering layer 3 bundled around the optical fiber 2 through a flame retardant bath containing a slurry of the halogen-free flame retarder in the form of a powder in order to apply (adhere) the flame retarder to the fiber buffering layer followed by drying the flame retarder by a drying furnace. More specifically speaking, for example, the slurry is prepared in advance by suspending an inorganic metal hydrate powder such as a magnesium hydroxide powder in ethyl alcohol and the like, and placed in the flame retardant bath.

Then, the high tension fibers 6 bundled around the optical fiber 2 is passed through the flame retardant bath in order to apply (adhere) the flame retarder to the fiber buffering layer. Thereafter, the high tension fibers 6 bundled around the optical fiber 2 is passed through, for example, a heating furnace in order to dry up the flame retarder and fix the flame retarder to the high tension fibers, thus forming the flame retardant layer.

By these manufacturing methods, the flame retardant optical fiber cord can be formed with the high tension fibers to which are applied the halogen-free flame retarder in the form of a powder. As a result, the flame retardant optical fiber cord as manufactured has sufficient flame retardancy to pass the UL 1581 Vertical Wire Flame Test VW-1, and to suppress the increment of the transmission loss no higher than 0.1 dB corresponding to the withstanding side pressure characteristics.

Next, a further manufacturing method of the flame retardant optical fiber cord will be explained. In accordance with the manufacturing method, the halogen-free flame retarder in the form of a powder has been applied, in advance, to an optical fiber or an optical fiber ribbon which is being transported followed by arranging in parallel the high tension fibers around the optical fiber or the optical fiber ribbon to form the fiber buffering layer. Next, the optical fiber or the optical fiber ribbon with the high tension fibers is covered with a plastic sheath by means of an extrusion apparatus to form the flame retardant optical fiber cord. In accordance with this manufacturing method, a conventional manufacturing apparatus can be used as it is so that the method is considered reasonable to employ.

Meanwhile, in the above manufacturing method, the high tension fibers can be made, in advance, flame retarder by passing the high tension fibers through a flame retardant bath containing a slurry of the halogen-free flame retarder in the form of a powder in order to apply (adhere) the flame retarder to the fiber buffering layer followed by drying the flame retarder by a drying furnace. Also, after passing the optical fiber through the flame retardant bath containing the halogen-free flame retarder in the form of a powder and applying (adhering) the halogen-free flame retarder at least to the fiber buffering layer, the optical fiber can be wound around a bobbin for storage.

Furthermore, there is another method of making flame retardant the high tension fibers in advance as follows. Namely, after arranging in parallel the high tension fibers around an optical fiber or an optical fiber ribbon which is being transported, the optical fiber or the optical fiber ribbon is passed through a flame retardant bath containing the powder halogen-free flame retarder in the form of a slurry as prepared by suspending the halogen-free flame retarder in ethyl alcohol and the like in order to apply (adhere) the halogen-free flame retarder at least to the fiber buffering layer. By this configuration, the flame retarder can be appled (adhered) at least to the fiber buffering layer. Then, after winding the optical fiber thus made flame retardant around a bobbin, the optical fiber is dried and covered with the plastic sheath to complete the manufacturing method. Alternatively, after drying the optical fiber thus made flame retardant and covering the optical fiber with the plastic sheath, the optical fiber is wound around a bobbin to complete the manufacturing method. In this case, there is no need for providing a particular processing system for the flame retardation process. Then, the flame retardant optical fiber cord of the structure as manufactured has a sufficient flame retardancy to pass the UL 1581 Vertical Wire Flame Test VW-1 while the transmission loss is increased only by no higher than 0.1 dB as the increase in the withstanding side pressure characteristics.

Meanwhile, it is also preferred that the halogen-free flame retarder in the form of a powder used in the manufacturing method of the flame retardant optical fiber cord as described above has an average particle diameter of no larger than 1 micrometer. Namely, since the halogen-free flame retarder in the form of a powder as described above is applied to the fiber buffering layer 3 which is formed by arranging in parallel the high tension fibers made of aramid fibers and the like, it is therefore preferred that the powdered halogen-free flame retarder is not only applied to the entirety of the fiber buffering layer but also inserted to spaces among the aramid fibers and placed onto the optical fiber itself. For this reason, while the average particle diameter of the flame retarder is preferably small at a certain level, a number of experimental results indicate no larger than 1 micrometer as a preferred average particle diameter of the halogen-free flame retarder in the form of a powder as described above preferably. If the average particle diameter is small in this level, it is possible to uniformly cover the entirety of the fiber buffering layer 3 with the particles, to insert the particles to spaces among the high tension fibers and apply the powder onto the optical fiber 2 itself.

Next, a flame retardant optical fiber cord in accordance with another embodiment of the present invention will be explained as well as the method of manufacturing the same. The flame retardant optical fiber cord in accordance with this embodiment is formed by providing a fiber buffering layer made of high tension fibers and then a plastic sheath on an optical fiber or an optical fiber ribbon. At least the high tension fibers is made flame retardant with a halogen-free flame retarder in the form of a solution. By this configuration, the mechanical characteristics of the optical fiber cord as obtained are not compromised so that the optical fiber cord is excellent in suppleness (flexibility) and in flame retardancy due to the flame retardancy of the halogen-free flame retarder. Also, the flame retardant optical fiber cord can be manufactured by a relatively simple manufacturing method and in compliance with the requirement for decreasing the diameter thereof.

In accordance with the manufacturing method making use of the halogen-free flame retarder in the form of a solution, it is possible to manufacture a flame retardant optical fiber cord having the same geometrical characteristics as illustrated in FIG. 1 and FIG. 2. Then, the flame retardant optical fiber cord of the structure thus obtained has a sufficient flame retardancy to pass the UL 1581 Vertical Wire Flame Test VW-1 while the transmission loss is increased only by no higher than 0.1 dB as the increase in the withstanding side pressure characteristics.

More specifically explaining, an optical fiber usually includes an optical fiber core wire covered by a coating layer made of, for example, a rigid UV curable resin, a polyamide resin or a polyolefin base resin. In accordance with the present invention, it is possible to dispense with the treatment required for making flame retardant this coating layer. This means that the mechanical characteristics of the optical fiber cord as obtained are not compromised so that the optical fiber cord is excellent in suppleness (flexibility). Then, located around the optical fiber in parallel are high tension fibers such as aramid fibers (proprietary name: Kevler, Twaron and the like), PBO (proprietary name: Xyron and the like) and so forth. For example, four KEVLAR fibers 1140d are arranged as high tension fibers around a single fiber having a diameter of 0.9 mm. At least the high tension fibers are made flame retardant with a halogen-free flame retarder in the form of a solution. More specifically speaking, the halogen-free flame retarder is applied to the high tension fibers by adherence or impregnation as illustrated in FIG. 2A and FIG. 2B. This type of halogen-free flame retarders can be prepared, for example, with a nitrogen based flame retarder such as ammonium polyphosphate, an phosphoric ester such as resorcinol diphenylphosphate, red phosphorus, a melamine cyanurate, a melamine powder and the like. Particularly, the halogen-free flame retarder is preferably prepared with a water soluble material such as resorcinol diphenylphosphate. Also, the plastic sheath is typically made of a thermoplastic polymer resin. For example, the plastic sheath 5 is formed of a polyolefin base copolymer alone or as a component of a mixture, for example, an ethylene vinyl acetate copolymer, an ethylene acrylic rubber copolymer, ethylene ethyl acrylate copolymer and the like, or a polyamide resin, a polyester resin, a polybutylehe terephthalate (PBT) and the like in accordance with an extrusion method. Then, in the case of the flame retardant optical fiber cord 1 in accordance with the present invention, it is no longer needed to make highly flame retardant the plastic sheath 5 by adding a large amount of the inorganic metal hydrate and therefore it is possible to maintain the characteristics required of the plastic sheath 5, for example, a tensile stress strength of no lower than 10 MPa and an elongation at break of no lower than 100%. Also, in accordance with the present invention, it is preferred that the flame retardant treatment is carried out within 39 to 55 as an Oxygen Index (OI) in order not to compromise the mechanical characteristics as described above. Furthermore, it was confirmed that this structure of the flame retardant optical fiber cord had sufficient flame retardancy to pass the UL 1581 Vertical Wire Flame Test VW-1, and to suppress the increment of the transmission loss no higher than 0.1 dB as the increase in the withstanding side pressure characteristics.

Next, a method of manufacturing the flame retardant optical fiber cord as described above will be explained. Namely, after arranging in parallel the high tension fibers around an optical fiber or an optical fiber ribbon which is being transported, the optical fiber or the optical fiber ribbon is passed through a flame retardant bath containing the halogen-free flame retarder in the form of a solution in order to apply (adhere) the halogen-free flame retarder at least to the fiber buffering layer. After drying the flame retarder by a heating (drying) furnace, the optical fiber or the optical fiber ribbon is covered with a plastic sheath by means of an extrusion apparatus to obtain a flame retardant optical fiber cord having the characteristics as described above.

Next, the manufacturing method of the flame retardant optical fiber cord as described above will be explained in detail. It is assumed here that the optical fiber 2 is transported from the left as illustrated in FIG. 6. On the other hand, high tension fibers 6 such as aramid fibers or polyparaphenylenebenzobisoxazole (PBO) fibers are also transported from the left and arranged around the optical fiber 2 in parallel through guide means 7. The optical fiber 2 and the high tension fibers 6 are then bundled by means of a bundling die 8 to form the fiber buffering layer 3. After forming the fiber buffering layer 3, the optical fiber 2 is passed through the flame retardant bath 10 containing the flame retarder 11 made of a water solution of resorcinol diphenylphosphate in order to attach the flame retarder to the high tension fibers 6. Next, the optical fiber 2 provided with the flame retarder is passed through a heating furnace designated by reference 12 in order to dry the flame retarder and fix the flame retarder to the optical fiber 2 with the high tension fibers for flame retardation.

Then, the optical fiber 2 provided with the flame retardant layer is then successively transported to an extrusion apparatus where the optical fiber 2 is covered with the plastic sheath 5 to form the flame retardant optical fiber cord 1. Meanwhile, the plastic sheath 5 is made of a thermoplastic plastic which is made flame retardant with the flame retarder as described above. By this configuration of the manufacturing method, it is possible to form the fiber buffering layer 3 with high flame retardancy and without need for particularly providing a large scale apparatus. Then, the flame retardant optical fiber cord of the structure as obtained has a sufficient flame retardancy to pass the UL 1581 Vertical Wire Flame Test VW-1, while the transmission loss is increased only by no higher than 0.1 dB by applying the flame retarder, and has excellent mechanical characteristics such as a good suppleness and a good flexibility.

Next, a further manufacturing method of the flame retardant optical fiber cord will be explained. In accordance with the manufacturing method, after arranging in parallel the high tension fibers around an optical fiber or an optical fiber ribbon which is being transported, the optical fiber or the optical fiber ribbon is passed through a flame retardant bath containing the halogen-free flame retarder in the form of a solution in order to apply (adhere) the halogen-free flame retarder at least to the fiber buffering layer. Then, after drying the solution with a heating (drying) furnace, the optical fiber is covered with a plastic sheath by means of an extrusion apparatus to form a flame retardant optical fiber cord having the characteristics as described above.

FIG. 7 is an explanatory view for explaining the further manufacturing method of a flame retardant optical fiber cord in accordance with the present invention. In this case, it is assumed that the optical fiber 2 is transported from the left. On the other hand, high tension fibers 6 such as aramid fibers or polyparaphenylenebenzobisoxazole (PBO) fibers are also transported from the left and arranged around the optical fiber 2 in parallel through guide means 7. The optical fiber 2 and the high tension fibers 6 are then bundled by means of a bundling die 8 to form the fiber buffering layer 3. After forming the fiber buffering layer 3, the optical fiber 2 is passed through a spray chamber 13 in which is sprayed a water solution of an phosphoric ester such as resorcinol diphenylphosphate. At least two nozzles 14 are provided (in upper and lower locations in this case) in the spray chamber 13. The nozzles 14 are connected to a storage chamber 15 holding the flame retarder through a hose 16 and the like and used to spray the flame retarder therethrough by air pressure. For this reason, it is preferred that the flame retarder is handled as a solution. In this manner, the flame retarder is applied (adhered) to the high tension fibers 6. Next, the optical fiber 2 provided with the flame retarder is passed through a heating furnace designated by reference 12 in order to dry the flame retarder and fix the flame retarder to the optical fiber 2 with the high tension fibers for flame retardation.

Then, the optical fiber 2 provided with the flame retardant layer is then successively transported to an extrusion apparatus where the optical fiber 2 is covered with the plastic sheath 5 to form the flame retardant optical fiber cord 1. Meanwhile, the plastic sheath 5 is made of a thermoplastic plastic which is made flame retardant with the flame retarder as described above. By this configuration of the manufacturing method, it is possible to form the fiber buffering layer 3 with high flame retardancy and without need for particularly providing a large scale apparatus. Then, the flame retardant optical fiber cord of the structure as obtained has a sufficient flame retardancy to pass the UL 1581 Vertical Wire Flame Test VW-1, while the transmission loss is increased only by no higher than 0.1 dB by applying the flame retarder, and has excellent mechanical characteristics such as a good suppleness and a good flexibility.

Next, a further manufacturing method of the flame retardant optical fiber cord will be explained. In accordance with the manufacturing method, the halogen-free flame retarder in the form of a solution is applied, in advance, to an optical fiber or an optical fiber ribbon which is then transported for arranging in parallel the high tension fibers around the optical fiber or the optical fiber ribbon to form the fiber buffering layer. Next, the optical fiber or the optical fiber ribbon with the high tension fibers is covered with a plastic sheath by means of an extrusion apparatus to form the flame retardant optical fiber cord. In accordance with this manufacturing method, a conventional manufacturing apparatus can be used as it is so that the method is considered reasonable to employ. Meanwhile, in the above manufacturing method, the high tension fibers can be made flame retardant, in advance, by passing the high tension fibers through a flame retardant bath containing the solution of the halogen-free flame retarder as described above in order to apply (adhere) the flame retarder to the fiber buffering layer followed by drying the flame retarder by a drying furnace. Also, the high tension fibers may be made flame retardant by spraying the fiber buffering layer with a solution of the flame retarder in order to apply (adhere) the flame retarder thereto followed by drying the flame retarder by a drying furnace. Furthermore, the high tension fibers may be made flame retardant by passing the high tension fibers through a flame retardant bath containing the halogen-free flame retardant powder as described above in order to apply (adhere) the flame retarder to the fiber buffering layer followed by drying the flame retarder by a drying furnace and then winding the optical fiber around a bobbin. Then, the flame retardant optical fiber cord of the structure as obtained has a sufficient flame retardancy to pass the UL 1581 Vertical Wire Flame Test VW-1, while the transmission loss is increased only by no higher than 0.1 dB by applying the flame retarder, and has excellent mechanical characteristics such as a good suppleness and a good flexibility.

Furthermore, there is another method of making flame retardant the high tension fibers in advance as follows. Namely, after arranging in parallel the high tension fibers around an optical fiber or an optical fiber ribbon which is being transported, the optical fiber or the optical fiber ribbon is passed through a flame retardant bath containing the halogen-free flame retarder in the form of a solution in order to apply (adhere) the halogen-free flame retarder at least to the fiber buffering layer. Then, after winding the optical fiber thus made flame retardant around a bobbin, the optical fiber is dried and covered with the plastic sheath to complete the manufacturing method. Alternatively, after drying the optical fiber thus made flame retardant and covering the optical fiber with the plastic sheath, the optical fiber is wound around a bobbin to complete the manufacturing method. Also, the high tension fibers may be made flame retardant by spraying the fiber buffering layer with a solution of the flame retarder in order to apply (adhere) the flame retarder thereto followed by drying the flame retarder by a drying furnace. Alternatively, after vaporizing the soluvent of the solution from the optical fiber and covering the optical fiber with the plastic sheath, the optical fiber is wound around a bobbin to complete the manufacturing method. Accordingly, there is no need for providing a particular processing system for the flame retardation process. Then, the flame retardant optical fiber cord of the structure as obtained has a sufficient flame retardancy to pass the UL 1581 Vertical Wire Flame Test VW-1, while the transmission loss is increased only by no higher than 0.1 dB by applying the flame retarder, and has excellent mechanical characteristics such as a good suppleness and a good flexibility.

Accordingly, there are following advantages in accordance with the present invention.

In accordance with the embodiment of the present invention, the optical fiber cord is formed by providing a fiber buffering layer made of high tension fibers and then a plastic sheath on an optical fiber or an optical fiber ribbon wherein at least the fiber buffering layer is given a flame retardant treatment with a halogen-free flame retarder in the form of a powder, and therefore the mechanical characteristics of the optical fiber cord as obtained are not compromised so that the optical fiber cord is excellent in suppleness (flexibility) and in flame retardancy due to the flame retardancy of the halogen-free flame retarder. Needless to say, the flame retardant optical fiber cord does not generate any halogen compound even when burned. Also, while the flame retardation can be performed by a variety of alternate techniques, it is basically preferred that the halogen-free flame retarder is sufficiently applied or attached (or held) to the high tension fibers and to the inside of the fiber buffering layer when forming the fiber buffering layer. Also, in accordance with the present invention, it is possible to improve the flame retardation characteristics of the flame retardant optical fiber cord, equivalent to the prior art flame retardant optical fiber cord as described above, by the flame retardation process in which the flame retardant layer of the halogen-free flame retarder in the form of a powder is formed at least on the fiber buffering layer. Furthermore, since the halogen-free flame retarder is made flame retardant by coating (adhering) a flame retarder in the form of a powder onto the fiber buffering layer, the flame retarder tend to be effective and advantageous, resulting in a highly flame retardant optical fiber cord. In addition to this, in accordance with the present invention, while a flame retardant optical fiber cord has sufficient flame retardancy to pass the UL 1581 Vertical Wire Flame Test VW-1, it is possible to dispense with the treatment required for making flame retardant the optical fiber itself and therefore to obtain a sufficient tensile stress strength (MPa), a sufficient elongation at break (%) as a highly flame retardant optical fiber cord, a sufficient withstanding side pressure, a sufficient resistance against bending stresses. Also, since this flame retardant optical fiber cord 1 contains no halogen element, a harmful gaseous halogen such as dioxin shall not be generated and therefore environmental problems and the like shall not be issued.

Since the amount of the halogen-free flame retarder in the form of a powder to be applied to the high tension fibers is one or more gram per meter of the high tension fibers during the flame retardation treatment, the flame retardant optical fiber cord of the structure has a sufficient flame retardancy to pass the UL 1581 Vertical Wire Flame Test VW-1, while the transmission loss is increased only by no higher than 0.1 dB by applying the flame retarder, and has excellent mechanical characteristics such as a good suppleness and a good flexibility. Also, by making use of a halogen-free flame retarder in the form of a powder having an average particle diameter of no larger than 1 micrometer, the powdered halogen-free flame retarder is not only applied to the entirety of the fiber buffering layer but also inserted to spaces among the aramid fibers and placed onto the optical fiber itself. Furthermore, by making use of such a halogen-free flame retarder in the form of a powder having an average particle diameter of no larger than 1 micrometer, the powdered halogen-free flame retarder provided with the flame retardant layer has sufficient flame retardancy to pass the UL 1581 Vertical Wire Flame Test VW-1 and has excellent mechanical characteristics such as a good suppleness and a good flexibility, while the increment of the transmission loss is no higher than 0.1 dB.

Furthermore, in accordance with an embodiment of the present invention, after arranging in parallel high tension fibers around an optical fiber or an optical fiber ribbon which is being transported, the optical fiber or the optical fiber ribbon is passed through a flame retardant bath containing the halogen-free flame retarder in the form of a powder in order to apply (adhere) the halogen-free flame retarder at least to the fiber buffering layer. Thereafter, the optical fiber or the optical fiber ribbon is covered with a plastic sheath by means of an extrusion apparatus. Also, in this case, the application of the halogen-free flame retarder can be accelerated by shaking the flame retardant bath containing the halogen-free flame retarder in the form of a powder during application. As a result, it is possible to form the flame retardant layer entirely and uniformly on the fiber buffering layer. Shaking the flame retardant bath is effective to apply the halogen-free flame retarder not only to the surface of the fiber buffering layer 3 but also among the fibers as described above and also placed onto the optical fiber. The manufacturing method does not require a large-scale system and can be carried out with a low cost as compared to the case where a flame retarder is mixed in a plastic sheath.

In accordance with the manufacturing method, the halogen-free flame retarder in the form of a solution is applied, in advance, to an optical fiber or an optical fiber ribbon which is then transported for arranging in parallel the high tension fibers around the optical fiber or the optical fiber ribbon to form the fiber buffering layer. Then, the optical fiber or the optical fiber ribbon with the high tension fibers is covered with a plastic sheath by means of an extrusion apparatus to form the flame retardant optical fiber cord. a conventional manufacturing apparatus can be used as it is so that the method is considered reasonable to employ.

In accordance with another aspect of the present invention, the optical fiber cord is formed by providing a fiber buffering layer made of high tension fibers and then a plastic sheath on an optical fiber or an optical fiber ribbon wherein at least the fiber buffering layer is given a flame retardant treatment with a halogen-free flame retarder in the form of a solution, and therefore the mechanical characteristics of the optical fiber cord as obtained are not compromised so that the optical fiber cord is excellent in suppleness (flexibility) and in flame retardancy due to the flame retardancy of the halogen-free flame retarder. Also, the flame retardant optical fiber cord can be manufactured by a relatively simple manufacturing method and in compliance with the requirement for decreasing the diameter thereof. Namely, it is possible to improve the flame retardation characteristics of the optical fiber cord as illustrated in FIG. 1 and FIG. 2 equivalent to the prior art flame retardant optical fiber cord as described above. More specifically speaking, the flame retardant optical fiber cord of the structure thus obtained has a sufficient flame retardancy to pass the UL 1581 Vertical Wire Flame Test VW-1 while the transmission loss is increased only by no higher than 0.1 dB as the increase in the withstanding side pressure characteristics.

Namely, after arranging in parallel the high tension fibers around an optical fiber or an optical fiber ribbon which is being transported, the optical fiber or the optical fiber ribbon is passed through a flame retardant bath containing the halogen-free flame retarder in the form of a solution in order to apply (adhere) the halogen-free flame retarder at least to the fiber buffering layer. Then, after drying the flame retarder by a heating (drying) furnace, the optical fiber or the optical fiber ribbon is covered with a plastic sheath by means of an extrusion apparatus to obtain a flame retardant optical fiber cord having the characteristics as described above. As a result, the flame retardant optical fiber cord of the structure as obtained has a sufficient flame retardancy to pass the UL 1581 Vertical Wire Flame Test VW-1, while the transmission loss is increased only by no higher than 0.1 dB by applying the flame retarder, and has excellent mechanical characteristics such as a good suppleness and a good flexibility.

The foregoing description of the embodiments has been presented for purposes of illustration and description. It is not intended to be exhaustive or to limit the invention to the precise form described, and obviously many modifications and variations are possible in light of the above teaching. The embodiment was chosen in order to explain most clearly the principles of the invention and its practical application thereby to enable others in the art to utilize most effectively the invention in various embodiments and with various modifications as are suited to the particular use contemplated.

What is claimed is:

1. A flame retardant optical fiber cord comprising:
an optical fiber;
a fiber buffering layer comprising high tension fibers arranged on said optical fiber; and
a plastic sheath covering said fiber buffering layer,
wherein at least said fiber buffering layer is made flame retardant with a halogen-free flame retarder in the form of a powder.

2. The flame retardant optical fiber cord as set forth in claim 1 wherein said optical fiber is a single optical fiber.

3. The flame retardant optical fiber cord as set forth in claim 1 wherein said optical fiber is an optical fiber ribbon.

4. The flame retardant optical fiber cord as set forth in claim 1 wherein at least said fiber buffering layer is made flame retardant by forming, on said fiber buffering layer, the flame retardant layer made of said halogen-free flame retarder in the form of a powder.

5. The flame retardant optical fiber cord as set forth in claim 1 wherein at least said fiber buffering layer is made flame retardant by applying said halogen-free flame retarder in the form of a powder with a density of one or more gram per meter of said high tension fibers.

6. The flame retardant optical fiber cord as set forth in claim 1 wherein said plastic sheath is made of a halogen-free flame retardant resin compound.

7. The flame retardant optical fiber cord as set forth in claim 1 wherein said halogen-free flame retarder in the form of a powder has an average particle diameter of no larger than 1 micrometer.

8. The flame retardant optical fiber cord as set forth in claim 1 wherein said flame retardant optical fiber cord has a sufficient flame retardancy to pass the UL 1581 Vertical Wire Flame Test VW-1 while the transmission loss as increased is no higher than 0.1 dB.

9. A manufacturing method of manufacturing a flame retardant optical fiber cord comprising:
a step of arranging high tension fibers in parallel on an optical fiber and forming a fiber buffering layer;
a step of passing said optical fiber provided with said fiber buffering layer through a flame retardant bath containing a halogen-free flame retarder in the form of a powder and applying (adhering) said halogen-free flame retarder to at least said fiber buffering layer to form a flame retardant layer; and
a step of covering said optical fiber, on which is formed said flame retardant layer, with a plastic sheath by an extrusion apparatus.

10. The manufacturing method as set forth in claim 9 wherein said optical fiber is a single optical fiber.

11. The manufacturing method as set forth in claim 9 wherein said optical fiber is an optical fiber ribbon.

12. The manufacturing method as set forth in claim 9 wherein the flame retardant bath containing said halogen-free flame retarder in the form of a powder is shaken during formation of said flame retardant layer.

13. A manufacturing method of manufacturing a flame retardant optical fiber cord comprising:
a step of arranging high tension fibers in parallel on an optical fiber and forming a fiber buffering layer;
a step of passing said optical fiber provided with said fiber buffering layer through a flame retardant bath containing a slurry of a halogen-free flame retarder in the form of a powder and applying (adhering) said halogen-free flame retarder to at least said fiber buffering layer to form a flame retardant layer; and
a step of drying said optical fiber, to which said flame retardant layer is applied, by a drying furnace.

14. The flame retardant optical fiber cord as set forth in claim 13 wherein said optical fiber is a single optical fiber.

15. The flame retardant optical fiber cord as set forth in claim 13 wherein said optical fiber is an optical fiber ribbon.

16. A manufacturing method of manufacturing a flame retardant optical fiber cord comprising:
a step of arranging in parallel high tension fibers, which is made flame retardant in advance with a halogen-free flame retarder in the form of a powder, on an optical fiber and forming a fiber buffering layer; and
a step of covering said optical fiber, on which is formed said fiber buffering layer, with a plastic sheath by an extrusion apparatus.

17. The flame retardant optical fiber cord as set forth in claim 16 wherein said optical fiber is a single optical fiber.

18. The flame retardant optical fiber cord as set forth in claim 16 wherein said optical fiber is an optical fiber ribbon.

19. The manufacturing method as set forth in claim 1 wherein said halogen-free flame retarder in the form of a powder has an average particle diameter of no larger than 1 micrometer.

20. A flame retardant optical fiber cord comprising:
an optical fiber;
a fiber buffering layer comprising high tension fibers arranged on said optical fiber; and
a plastic sheath covering said fiber buffering layer,
wherein at least said high tension fibers is made flame retardant with a halogen-free flame retarder in the form of a powder.

21. The flame retardant optical fiber cord as set forth in claim 20, wherein said optical fiber is a single optical fiber.

22. The flame retardant optical fiber cord as set forth in claim 20 wherein said optical fiber is an optical fiber ribbon.

23. A manufacturing method of manufacturing a flame retardant optical fiber cord comprising:
a step of arranging high tension fibers in parallel on an optical fiber and forming a fiber buffering layer;
a step of passing said optical fiber provided with said fiber buffering layer through a flame retardant bath containing a halogen-free flame retarder in the form of a solution and applying (adhering) said halogen-free flame retarder to at least said fiber buffering layer to form a flame retardant layer;
a step of drying said optical fiber, to which said flame retardant layer is applied, by a drying furnace; and
a step of covering said optical fiber as dried with a plastic sheath by an extrusion apparatus.

24. The flame retardant optical fiber cord as set forth in claim 23 wherein said optical fiber is an optical fiber ribbon.

25. The flame retardant optical fiber cord as set forth in claim 23 wherein said optical fiber is a single optical fiber.

26. A manufacturing method of manufacturing a flame retardant optical fiber cord comprising:
a step of arranging high tension fibers in parallel on an optical fiber and forming a fiber buffering layer;
a step of spraying said optical fiber provided with said fiber buffering layer with a solution including a halogen-free flame retarder and applying (adhering) said halogen-free flame retarder to at least said fiber buffering layer to form a flame retardant layer; and
a step of drying said optical fiber, to which said flame retardant layer is applied, by a drying furnace; and
a step of covering said optical fiber as dried with a plastic sheath by an extrusion apparatus.

27. The flame retardant optical fiber cord as set forth in claim 26 wherein said optical fiber is a single optical fiber.

28. The flame retardant optical fiber cord as set forth in claim 26 wherein said optical fiber is an optical fiber ribbon.

29. A manufacturing method of manufacturing a flame retardant optical fiber cord comprising:
a step of arranging in parallel high tension fibers, which is made flame retardant in advance with a halogen-free flame retarder in the form of a solution, on an optical fiber and forming a fiber buffering layer; and
a step of covering said optical fiber as dried with a plastic sheath by an extrusion apparatus.

30. The flame retardant optical fiber cord as set forth in claim 29 wherein said optical fiber is a single optical fiber.

31. The flame retardant optical fiber cord as set forth in claim 29 wherein said optical fiber is an optical fiber ribbon.

32. A flame retardant optical fiber cord comprising:
a transparent wire having optical characteristics as required of said flame retardant optical fiber cord;
a primary coating layer directly covering the external surface of said fiber glass structure;
a secondary coating layer covering the external surface of said transparent wire through said primary coating layer;
a fiber buffering layer comprising high tension fibers arranged on said secondary coating layer; and
a plastic sheath covering said fiber buffering layer,
wherein a halogen-free flame retarder is interposed between said high tension fibers.

33. The flame retardant optical fiber cord as set forth in claim 32 wherein said halogen-free flame retarder comes into contact with said secondary coating layer.

34. A flame retardant optical fiber cord comprising:
a transparent wire having optical characteristics as required of said flame retardant optical fiber cord;
a primary coating layer directly covering the external surface of said fiber glass structure;
a secondary coating layer covering the external surface of said transparent wire through said primary coating layer;
a fiber buffering layer comprising high tension fibers arranged on said secondary coating layer; and
a flame retardant layer comprising a halogen-free flame retarder and covering said fiber buffering layer.
